(19) United States
(12) Patent Application Publication
(10) Pub. No.: US 2010/0287233 A1
(43) Pub. Date: Nov. 11, 2010

(54) RICH-MEDIA OFFERING SYSTEM AND CONTROL METHOD THEREOF

(75) Inventors: Joong-Yun Lee, Seoul (KR); Tae-Meon Bae, Daegu (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 12/810,263

(22) PCT Filed: Aug. 18, 2008
(86) PCT No.: PCT/KR2008/004788

§ 371 Date: Jun. 23, 2010

(30) Foreign Application Priority Data
Dec. 24, 2007 (KR) 10-2007-0136807

(51) Int. Cl. G06F 15/16

(52) U.S. Cl. 709/203; 709/231; 709/219

(57) ABSTRACT

Disclosed are a rich-media provision system and a control method thereof. The rich-media provision system includes: a media server for receiving predetermined element media constituting rich-media from an external server and storing the received element media; a media transmission server for providing the element media in the form of streaming and tracing a scene being currently reproduced by a terminal when predetermined capture input is detected; and a rich-media terminal for receiving and reproducing the traced scene. By the rich-media provision system, it is possible to previously capture and store a specific part of rich-media contents that a user desires, so that the user can use the captured part of the rich-media contents anywhere and anytime if necessary.

### TECHNICAL FIELD

The present invention relates to a rich-media provision system and a control method thereof. More particularly, the present invention relates to a rich-media provision system and a control method thereof, which can capture, store, and use a desired part of rich-media contents through user's predetermined input while receiving the rich-media contents in the form of streaming.

### BACKGROUND ART

In the past, computer and communication technologies were insufficient for storage and rapid transmission of mass data. However, as various limitations in the computer and communication technologies have been overcome, transmission of multimedia data such as moving pictures and voice through Internet and reproduction of the multimedia data have been increasing steadily. Media being widely used on such technological backgrounds include the rich-media.

Rich-media was originally used as an Internet advertisement term, which refers to a new type of media that contains rich information in comparison with conventional banners, and thus supports interaction between users on the Internet. However, the meaning of rich-media has been recently enlarged and generalized, so it is now regarded as multimedia applicable to various types of media.

According to conventional capture-related technologies, general moving pictures or images, and web-pages have respective capture sections with media clearly discriminated from each other, so it is relatively easy to capture and extract them. However, for the rich-media, a current scene is constituted by a combination of existing received scenes and multiple media, so a user has difficulty in capturing, storing and using a desired scene.

### DISCLOSURE

### Technical Problem

Accordingly, the present invention has been made to solve at least the above-mentioned problems occurring in the prior art, and the present invention provides a rich-media provision system and a control method thereof, which can capture and store a part of rich-media contents while receiving the rich-media contents in the form of streaming, so that a user can use only the stored rich-media contents if necessary.

Moreover, the present invention provides a rich-media provision system and a control method thereof, the rich-media provision system including: a media server for receiving predetermined element media constituting rich-media from an external server and storing the received element media; a media transmission server for providing the element media in the form of streaming and tracing a scene being currently reproduced by a terminal when predetermined capture input is detected; and a rich-media terminal for receiving and reproducing the traced scene.

Furthermore, the present invention provides a rich-media provision system and a control method thereof, the rich-media provision system including the media server having a buffer for providing the element media provided from the external server to the media transmission server, and the media server including: a media controller for tracing a scene being currently reproduced by the rich-media terminal from the buffer, by the capture input including capture start input and capture end input; a media synthesis unit for storing the traced scene; and a media transmission unit for providing the stored scene to the rich-media terminal.

### Technical Solution

In accordance with another aspect of the present invention, there is provided a system for providing rich-media, the system including: a media server for receiving and storing predetermined element media constituting rich-media from an external server; a media transmission server for providing the element media in the form of streaming and tracing a scene being currently reproduced by a terminal when predetermined capture input is detected; and a rich-media terminal for receiving and reproducing the traced scene.

Preferably, the media server includes a buffer for providing the element media provided from the external server to the media transmission server.

Preferably, the media transmission server also includes: a media controller for tracing a scene being currently reproduced by the rich-media terminal from the buffer, by the capture input including capture start input and capture end input; a media synthesis unit for storing the traced scene; and a media transmission unit for providing the stored scene to the rich-media terminal.

Preferably, the media controller requests the external server to provide the element media constituting the scene when there is no currently reproduced scene in the buffer.

Preferably, the media synthesis unit creates and stores the scene by using the element media that the external server is requested to provide.

Preferably, the media synthesis unit creates and stores a predetermined replacement scene when it is impossible to store any one of the traced scene and the element media constituting the scene.

Preferably, the media synthesis unit terminates the storage of the scene by the capture end input.

Preferably, the media synthesis unit also terminates the storage of the scene when the reproduction of corresponding rich-media contents is terminated without the capture end input.

Preferably, the media transmission server includes: a media controller for tracing a scene being currently reproduced by the rich-media terminal from the buffer, by the capture input including capture start input and capture end input; and a media transmission unit for providing the traced scene to the rich-media terminal.

Preferably, the rich-media terminal includes a media synthesis unit for storing the scene provided from the media transmission unit.

Preferably, the media controller also requests the external server to provide the element media constituting the scene when there is no currently reproduced scene in the buffer.

Preferably, the media transmission unit transmits to the media synthesis unit the element media that the external server is requested to provide.

Preferably, the media synthesis unit creates and stores the scene by using the received element media.

Preferably, the media synthesis unit creates and stores a predetermined replacement scene when it is impossible to store any one of the traced scene and the element media constituting the scene.

Preferably, the media synthesis unit terminates the storage of the scene in any one of a case where the capture end input is detected, and a case where reproduction of corresponding rich-media contents is terminated without the capture end input.

In accordance with another aspect of the present invention, there is provided a media transmission server of a rich-media provision system, the server including: a media controller for tracing a scene being currently reproduced by a terminal from a buffer of the rich-media provision system when predetermined capture input including capture start input and capture end input is detected; and a media transmission unit for providing the traced scene to the terminal.

Preferably, the server further includes a media synthesis unit for storing the traced scene, and for receiving element media constituting the scene from the external server, creating and storing the scene when there is no currently reproduced scene in the buffer.

Preferably, the media synthesis unit creates and stores a predetermined replacement scene when it is impossible to store any one of the traced scene and the element media constituting the scene.

Preferably, the media synthesis unit terminates the storage of the scene in any one of a case where the capture end input is detected and a case where reproduction of rich-media contents is terminated by a terminal without the capture end input.

In accordance with another aspect of the present invention, there is provided a control method of a rich-media provision system, the method including the steps of: receiving predetermined element media constituting rich-media from an external server; performing capture start input through a terminal; tracing if there is a scene currently reproduced by the terminal in a predetermined buffer when the capture start input is detected; storing the traced scene when there is the currently reproduced scene in the buffer; receiving element media constituting the scene from the external server to generate and store the scene when there is no currently reproduced scene in the buffer; providing the stored scene to a rich-media terminal; and reproducing the provided scene.

Preferably, the method further includes the step of creating and storing a predetermined replacement scene when it is impossible to store any one of the scene and element media constituting the scene.

Preferably, the method further includes the step of terminating the storage of the scene in any one of a case where capture end input is detected from the terminal, and a case where reproduction of rich-media contents is terminated in the terminal without the capture end input.

In accordance with another aspect of the present invention, there is provided a control method of a media transmission server in a rich-media provision system, the method including the steps of: performing capture start input through a terminal; tracing if there is a scene currently reproduced by the terminal in a predetermined buffer when the capture start input is detected; storing the traced scene when there is a currently reproduced scene in the buffer; receiving element media constituting the scene from an external server to generate and store the scene when there is no currently reproduced scene in the buffer; and providing the stored scene to a rich-media terminal.

Preferably, the method further includes the step of creating and storing a predetermined replacement scene when it is impossible to store any one of the scene and the element media constituting the scene.

Preferably, the method further includes the step of terminating the storage of the scene in any one of a case where capture end input is detected from a terminal, and a case where reproduction of rich-media contents is terminated in the terminal without the capture end input.

### ADVANTAGEOUS EFFECTS

By a rich-media provision system and a control method thereof according to the present invention, it is possible to trace, capture, and store a specific part of rich-media contents desired by a user from inside the system while the rich-media contents are being received in the form of streaming. It is also possible to receive element media from an external server, and create and store a scene, when it is impossible to trace the specific part of the rich-media contents.

Therefore, it is possible to capture and store a specific part of rich-media contents desired by a user, so that a user can use the captured part of the rich-media contents anywhere and anytime if necessary.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a rich-media provision system according to a first embodiment of the present invention;

FIG. 2 is a block diagram illustrating a rich-media provision system according to a second embodiment of the present invention;

FIG. 3 is a flowchart illustrating a first part of a control method of a rich-media provision system according to one embodiment of the present invention; and

FIG. 4 is a flowchart illustrating a second part of a control method of a rich-media provision system according to one embodiment of the present invention.

### BEST MODE

### Mode for Invention

Hereinafter, a preferred embodiment of the present invention will be described with reference to the accompanying drawings.

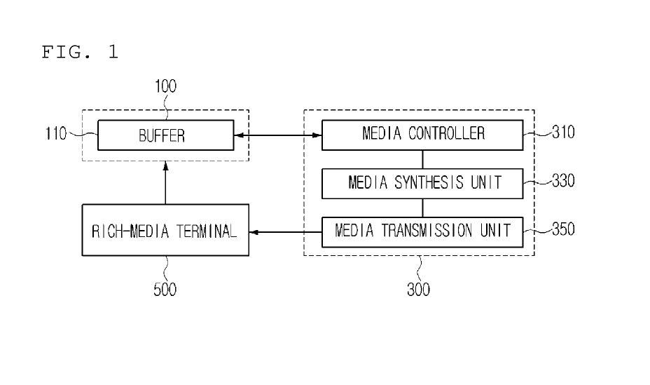

FIG. 1 is a block diagram illustrating a rich-media provision system.

The rich-media provision system according to a first embodiment of the present invention includes a media server 100, a media transmission server 300, and a rich-media terminal 500.

The media server 100 provides predetermined element media to the media transmission server 300 and the media server 100 may request an external server to provide predetermined element media, receive the requested element media, temporarily store the received element media, and provide the stored media to the media transmission server 300 in a streaming or download manner. It is preferred that the media server 100 may be implemented to have a buffer 110 temporarily storing element media, so as to solve a transmission rate difference between mutual servers when the media server 100 provides the received element media to the media transmission server 300. Herein, the element media refer to each of elements of the rich-media.

The media transmission server 300 transmits rich-media or element media itself to the rich-media terminal 500 (hereinafter, for convenience, referred to as “terminal 500”) in the form of streaming, the rich-media being synthesized by using the element media provided from the media server 100. It is preferred that the media transmission server 300 may trace and provide a scene being reproduced by the rich-media terminal 500 when predetermined capture input is detected. A process in which the media transmission server 300 traces and provides a currently reproduced scene will be described in more detail.

The media transmission server 300 includes a media controller 310, a media synthesis unit 330, and a media transmission unit 350.

The media controller 310 traces a scene being reproduced by the rich-media terminal 500 from the buffer 110 by predetermined capture input. That is, when capture start input is detected from the terminal 500 of a user, the media controller 310 inversely traces the scene being currently reproduced in the terminal 500. In this case, the media controller 310 first confirms if there is a traced scene in the buffer 110.

It is preferred that, when there is no traced scene in the buffer 110, the media controller 310 may request an external server to provide element media constituting the scene. Then, the media synthesis unit 330 may create a scene by using the element media that the external server is requested to provide. Hereinafter, the above-mentioned operation will be described.

The media synthesis unit 330 may synthesize rich-media through element media and store a scene traced by the media controller 310.

Preferably, as a result of the trace, when there is no scene being currently reproduced by the terminal 500, the media synthesis unit 330 may create and store a scene by using the element media that the media controller 310 requests the external server to provide.

Meanwhile, when it is impossible to store a traced scene or element media constituting a scene, the media synthesis unit 330 may create and store a predetermined replacement scene. Herein, the replacement scene is alternatively used when a scene that a user desires to capture is unavailable because it is impossible to store the traced scene or the element media constituting the scene. For example, the replacement scene may correspond to an empty image (several types of replacement scenes are possible). In addition, the replacement scene is used when there is a non-storable scene or it is impossible to store element media due to its nature.

Moreover, when capture end input is detected, the media synthesis unit 330 may terminate storage of the scene. In some cases, current reproduction of rich-media may be terminated before capture end input. In this case, the media synthesis unit 330 may also terminate storage of the scene. Furthermore, it goes without saying that the media synthesis unit 330 may terminate storage of the scene when the scene exceeds the storage capacity.

The media transmission unit 350 provides a scene, stored by the media synthesis unit 330, to the terminal 500.

The rich-media terminal 500, which is a terminal capable of reproducing rich-media, may include a cellular phone, a portable terminal with an electronic book, a personal computer, and so on. It is preferred that the rich-media terminal 500 may receive and reproduce a scene provided from the media transmission server 300 or the media transmission unit 350.

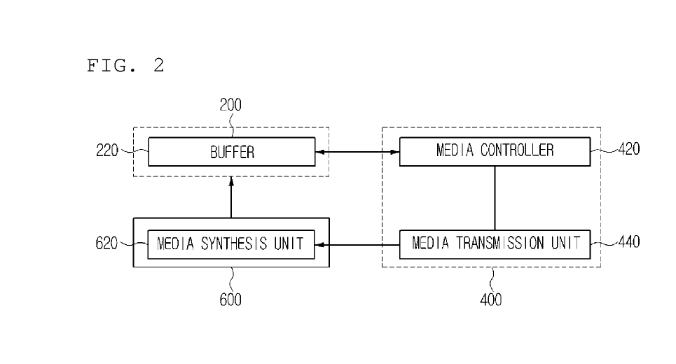

FIG. 2 is a block diagram illustrating a rich-media provision system according to a second embodiment of the present invention.

The rich-media provision system according to the second embodiment of the present invention includes a media server 200, a media transmission server 400 and a rich-media terminal 600 (hereinafter, for convenience, referred to as “terminal 600”).

The components of the second embodiment are similar to the components of the above-described first embodiment except for the media synthesis unit 330 and a media synthesis unit 620, so a detailed description thereof will be omitted.

The same description as in the first embodiment can be given on the media server 200 and the buffer 220.

The media transmission server 400 is also similar in function to that of the first embodiment, so that the same description as in the first embodiment can be given on a media controller 420 and a media transmission unit 440.

Meanwhile, the rich-media terminal 600 provides a scene traced by the media controller 420 to the rich-media terminal 600. It is preferred that the rich-media terminal 600 may be implemented to include the media synthesis unit 620.

In general, the media synthesis unit 620 functions to synthesize rich-media by using element media, and to store a scene traced by the media controller 310. The media synthesis unit 620 is similar in function to that of the first embodiment. Therefore, the media synthesis unit 620 performs operations of scene creation/storage, replacement scene creation/storage, and scene storage termination, as in the first embodiment.

The rich-media terminal 600 operates, as in the first embodiment.

The media transmission servers 300 and 400 may be implemented to have several structures whether the media synthesis units 330 and 620 are incorporated into the media transmission server 300 or the 600 according to embodiments, as described with reference to FIGS. 1 and 2.

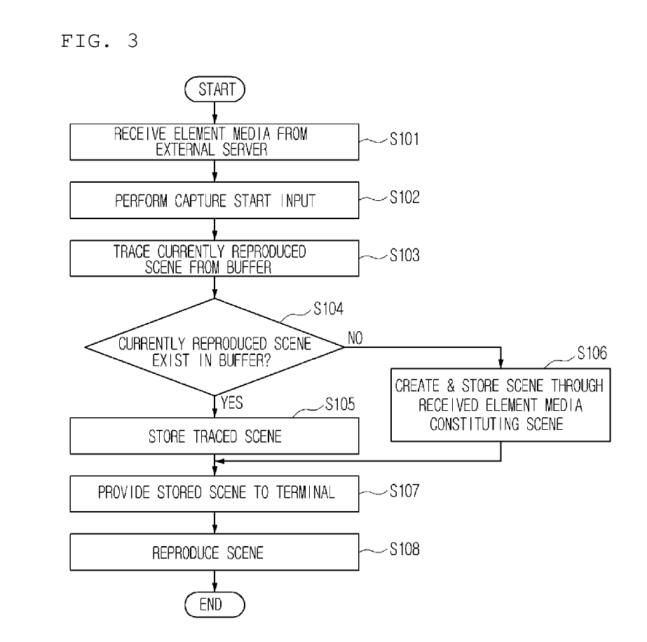

FIG. 3 is a flowchart illustrating a first part of a control method of a rich-media provision system according to one embodiment of the present invention.

Referring to FIG. 3, a procedure of the first part of the control method of the rich-media provision system according to one embodiment of the present invention will be described in more detail.

A user uses terminals 500 and 600 so as to request an external server to provide element media constituting rich-media and receive the requested element media (step S101).

Then, the user performs capture start input through the terminals 500 and 600 (step S102).

A scene being currently reproduced by the terminals 500 and 600 is traced from the buffers 110 and 220 (step S103).

It is determined if there is a currently reproduced scene in the buffers 110 and 220 (step S104). Referring to FIG. 3, although the steps of tracing (S103) and determining a currently reproduced scene (S104) can be expressed as a single step, they are separately described as above for convenience of description and drawing illustration.

As a result of the determination, when there is a currently reproduced scene in the buffers 110 and 220, a traced scene is stored (step S105).

As a result of the determination, when there is no currently reproduced scene in the buffers 110 and 220, element media constituting the traced scene is provided from the external server and then a scene is created and stored (step S106).

The stored scene is then provided to the terminals 500 and 600 (step S107).

Next, the provided scene is reproduced by the terminals 500 and 600 (step S108).

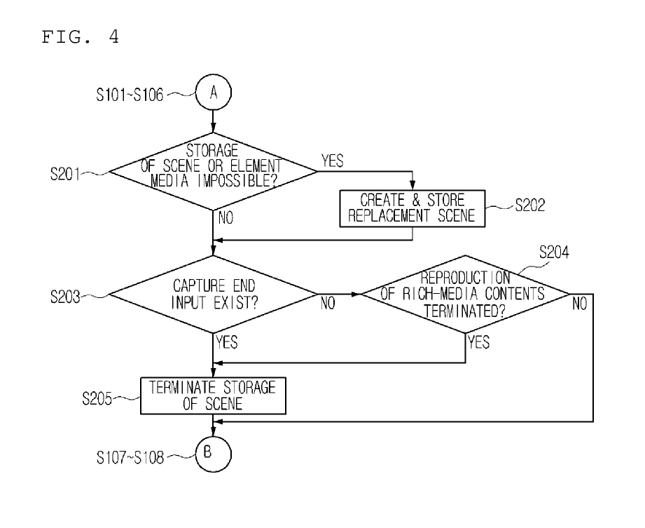

FIG. 4 is a flowchart illustrating a second part of a control method of a rich-media provision system according to one embodiment of the present invention.

Referring to FIG. 4, a procedure of the second part of the control method of the rich-media provision system according to one embodiment of the present invention will be described in more detail. Herein, the second part of the control method of the rich-media provision system denotes a part to be inserted between steps S101 to S106 and step S107.

It is then determined if it is impossible to store the scene traced from the buffers 110 and 220 (including a scene created from the element media because there is no scene in the buffers 110 and 220) or the element media constituting the scene (step S201).

As a result of the determination, when it is impossible to store the scene or the element media, the replacement scene is created and stored (step S202).

It is determined if capture end input is detected (step S203).

It is determined if the reproduction of corresponding rich-media contents is terminated in the terminals 500 and 600, without the capture end input (step S204).

As a result of the determination in step S204, when the reproduction of the rich-media contents is terminated in the terminals 500 and 600 without the capture end input, the storage of the scene is terminated (step S205).

Thereafter, the process returns to step S107.

### INDUSTRIAL APPLICABILITY

The present invention relates to a rich-media provision system and a control method thereof. More particularly, the present invention relates to a rich-media provision system and a control method thereof, which captures and stores a desired part of rich-media contents by predetermined input, thereby using the stored part of the rich-media contents, while the rich-media contents are being received in the form of the streaming.

According to the present invention, it is possible to trace, capture, and store a specific part of rich-media contents desired by a user from inside this system while the rich-media contents are being received in the form of the streaming. It is also possible to create and store a scene after receiving element media from an external server when it is impossible to trace a desired part of the rich-media contents. Accordingly, it is possible to previously capture and store a specific part of the rich-media contents that a user desires, so that the user can use the captured part of the rich-media contents anywhere and anytime, if necessary.

While this invention has been described in connection with what is presently considered to be the most practical and preferred embodiment, it is to be understood that the present invention is not limited to the disclosed embodiment and the drawings, but, on the contrary, it is intended to cover various modifications and variations within the spirit and scope of the appended claims.

1. A system for providing rich-media, the system comprising:
a media server for receiving and storing predetermined element media constituting rich-media from an external server;
a media transmission server for providing the element media in the form of streaming and tracing a scene being currently reproduced by a terminal when predetermined capture input is detected; and
a rich-media terminal for receiving and reproducing the traced scene.

2. The system as claimed in claim 1, wherein the media server comprises a buffer for providing the element media provided from the external server to the media transmission server.

3. The system as claimed in claim 2, wherein the media transmission server comprises:
a media controller for tracing a scene being currently reproduced by the rich-media terminal from the buffer, by the capture input including capture start input and capture end input;
a media synthesis unit for storing the traced scene; and
a media transmission unit for providing the stored scene to the rich-media terminal.

4. The system as claimed in claim 3, wherein the media controller requests the external server to provide the element media constituting the scene when there is no currently reproduced scene in the buffer.

5. The system as claimed in claim 4, wherein the media synthesis unit creates and stores the scene by using the element media that the external server is requested to provide.

6. The system as claimed in claim 3, wherein the media synthesis unit creates and stores a predetermined replacement scene when it is impossible to store any one of the traced scene and the element media constituting the scene.

7. The system as claimed in claim 3, wherein the media synthesis unit terminates the storage of the scene by the capture end input.

8. The system as claimed in claim 3, wherein the media synthesis unit terminates the storage of the scene when the reproduction of corresponding rich-media contents is terminated without the capture end input.

9. The system as claimed in claim 2, wherein the media transmission server comprises:
a media controller for tracing a scene being currently reproduced by the rich-media terminal from the buffer, by the capture input including capture start input and capture end input; and
a media transmission unit for providing the traced scene to the rich-media terminal.

10. The system as claimed in claim 9, wherein the rich-media terminal comprises a media synthesis unit for storing the scene provided from the media transmission unit.

11. The system as claimed in claim 10, wherein the media controller requests the external server to provide the element media constituting the scene when there is no currently reproduced scene in the buffer.

12. The system as claimed in claim 11, wherein the media transmission unit transmits to the media synthesis unit the element media that the external server is requested to provide.

13. The system as claimed in claim 12, wherein the media synthesis unit creates and stores the scene by using the received element media.

14. The system as claimed in claim 10, wherein the media synthesis unit creates and stores a predetermined replacement scene when it is impossible to store any one of the traced scene and the element media constituting the scene.

15. The system as claimed in claim 10, wherein the media synthesis unit terminates the storage of the scene in any one of a case where the capture end input is detected, and a case where reproduction of corresponding rich-media contents is terminated without the capture end input.

16. A media transmission server of a rich-media provision system, the server comprising:
a media controller for tracing a scene being currently reproduced by a terminal from a buffer of the rich-media provision system when predetermined capture input including capture start input and capture end input is detected; and
a media transmission unit for providing the traced scene to the terminal.

17. The server as claimed in claim 16, further comprising a media synthesis unit for storing the traced scene, and for receiving element media constituting the scene from the external server, creating and storing the scene when there is no currently reproduced scene in the buffer.

18. The server as claimed in claim 16, wherein the media synthesis unit creates and stores a predetermined replacement scene when it is impossible to store any one of the traced scene and the element media constituting the scene.

19. The server as claimed in claim 17, wherein the media synthesis unit terminates the storage of the scene in any one of a case where the capture end input is detected, and a case where reproduction of rich-media contents is terminated by a terminal without the capture end input.

20. A control method of a rich-media provision system, the method comprising the steps of:
receiving predetermined element media constituting rich-media from an external server;
performing capture start input through a terminal;
tracing if there is a scene currently reproduced by the terminal in a predetermined buffer when the capture start input is detected;
storing the traced scene when there is the currently reproduced scene in the buffer;
receiving element media constituting the scene from the external server to generate and store the scene when there is no currently reproduced scene in the buffer;
providing the stored scene to a rich-media terminal; and
reproducing the provided scene.

21. The method as claimed in claim 20, further comprising a step of creating and storing a predetermined replacement scene when it is impossible to store any one of the scene and element media constituting the scene.

22. The method as claimed in claim 20, further comprising a step of terminating the storage of the scene in any one of a case where capture end input is detected from the terminal, and a case where reproduction of rich-media contents is terminated in the terminal without the capture end input.

23. A control method of a media transmission server in a rich-media provision system, the method comprising the steps of:
performing capture start input through a terminal;
tracing if there is a scene currently reproduced by the terminal in a predetermined buffer when the capture start input is detected;
storing the traced scene when there is a currently reproduced scene in the buffer;
receiving element media constituting the scene from an external server to generate and store the scene when there is no currently reproduced scene in the buffer; and
providing the stored scene to a rich-media terminal.

24. The method as claimed in claim 23, further comprising a step of creating and storing a predetermined replacement scene when it is impossible to store any one of the scene and the element media constituting the scene.

25. The method as claimed in claim 23, further comprising a step of terminating the storage of the scene in any one of a case where capture end input is detected from a terminal, and a case where reproduction of rich-media contents is terminated in the terminal without the capture end input.
